(19) United States
(12) Patent Application Publication
(10) Pub. No.: US 2024/0055720 A1
(43) Pub. Date: Feb. 15, 2024

(54) SECONDARY BATTERY INCLUDING GAS ADSORPTION MATERIAL, AND SECONDARY BATTERY MODULE

(71) Applicant: LG ENERGY SOLUTION, LTD., Seoul (KR)

(72) Inventors: In Young CHA, Daejeon (KR); Sung Hoon YU, Daejeon (KR); Nak Gi SUNG, Daejeon (KR)

(73) Assignee: LG ENERGY SOLUTION, LTD., Seoul (KR)

(21) Appl. No.: 18/267,152

(22) PCT Filed: Oct. 7, 2022
(86) PCT No.: PCT/KR2022/015169

§ 371 Date: Jun. 14, 2023

(30) Foreign Application Priority Data
Nov. 16, 2021 (KR) 10-2021-0157299

(51) Int. Cl. H01M 50/383

(52) U.S. Cl. CPC H01M 50/383; H01M 2200/20

(57) ABSTRACT

A secondary battery and a module thereof is disclosed, which has an electrode assembly and a case into which the electrode assembly is inserted. The case has an inner side with a coating layer containing a gas absorbing material, which absorbs or desorbs internal gas depending on the temperature inside the case. The secondary battery may enhance safety, in terms of improving battery heat transfer and preventing fire, by not only absorbing internal gas at normal operating temperatures but also desorbing internal gas at high temperatures. This may allow the secondary battery to regulate the internal gas emission point based on an internal pressure critical point when the battery is exposed to an abnormally high temperature. In addition, the secondary battery inhibits deformation of the battery case and is highly effective in preventing degradation of the battery performance by regulating the pressure inside the battery case.

### TECHNICAL FIELD

The present invention relates to a secondary battery that has a material, which absorbs/desorbs gas depending on the temperature condition, coated on the inner side of a battery case, and it relates to a secondary battery module including the same.

This application claims the benefit of priority based on Korean Patent Application No. 10-2021-0157299, filed on Nov. 16, 2021, and the entire contents of the Korean patent application are incorporated herein by reference.

### BACKGROUND TECHNOLOGY OF THE INVENTION

Recently, as the technology development and demand for mobile devices increases, and as electric vehicles (EV) become more and more popularized, the demand for a battery as an energy source has been sharply increasing. Accordingly, many researches related to the battery are being done to meet those various demands.

Typically, in terms of the shape of the battery, there is a high demand for a prismatic secondary battery and a pouch-type secondary battery which can be applied to appliances such as a mobile phone in a thin layer, and in terms of the material of the battery, there is a high demand for lithium secondary batteries such as a lithium-ion battery and a lithium-ion polymer battery which have advantages such as high energy density, high discharge voltage, high output stability, etc.

However, despite these advantages, the lithium secondary battery has drawbacks in terms of stability. Specifically, gas is generated when electrolyte reacts during first charging, aging, and charge/discharge right after electrolyte gets injected into a battery assembly. And the gas generated causes problems such as decrease in capacity and lithium deposition by being trapped inside the battery.

In addition, when large amount of gas gets produced, the pressure between the case and the battery assembly, also known as the dead space, increases, making the gas trapped inside the battery assembly hard to be emitted to the dead space, and the battery performance may be degenerated due to the trapped gas. Moreover, it increases the internal pressure of the battery and causes deformation in a cylindrical or a prismatic battery case, and serious problems such as explosion of a secondary battery may also occur.

In order to solve the above-mentioned problems, means of gas emission are often formed on the case in order to lower the internal pressure by emitting gas generated inside the secondary battery case to the outside. However, because the means of gas emission rupture in relatively high critical temperature and because the internal pressure of the battery slowly increases, when one among the multiple individual secondary batteries within the secondary battery module shows abnormal increase in temperature, heat is transferred to the adjacent secondary battery, and it can either cause a normal secondary battery to stop working due to series of rupture in means of gas emission, or cause decrease in the battery performance.

### DESCRIPTION OF THE INVENTION

### Technical Problem

The present invention is invented to solve above-mentioned problems, and it is directed to provide a secondary battery and a secondary battery module comprising the same that absorbs gas inside the battery in a normal operating temperature, and that can vent gas to the outside of the case by quickly emitting gas to increase the internal pressure and quickly reaching a pressure critical point when abnormal increase in the temperature occurs.

The present invention is also directed to provide a secondary battery that absorbs gas generated in a normal operating temperature of a secondary battery, inhibits deformation in the battery case by lowering the pressure inside the battery case, and does not degrade the battery performance.

### Technical Solution

To solve the above-described problem, The present invention, in one embodiment, provides a secondary battery that includes an electrode assembly; and
a case where the electrode assembly gets inserted,
wherein the case has a coating layer on the inner side that contains a gas absorbing material that absorbs or desorbs internal gas depending on the temperature inside the case.

Here, the gas absorbing material may have a critical temperature between 70 and 150° C., and it may absorb internal gas below the critical temperature and may desorb internal gas at or above the critical temperature.

Such gas absorbing material may include a diamine compound that include one or more metals selected from the group consisting of magnesium, manganese, iron, zinc, and cobalt, and the diamine compound may comprise one or more selected from the group consisting of mmen-Mg2(dobpdc), mmen-Mn2(dobpdc), mmen-Fe2(dobpdc), mmen-Zn2(dobpdc), and mmen-Co2(dobpdc).

In addition, the gas absorbing material may include one or more selected from the group consisting of carbon fiber, activated carbon, zeolite, alumina, silica, bauxite, and molecular sieves.

Furthermore, the coating layer may include a first gas absorbing material that has a critical temperature of 70 to 110° C.; a second gas absorbing material that has a critical temperature of 110 to 140° C.; and a binder.

In addition, the first gas absorbing material and the second gas absorbing material each may be included at 60 to 80 wt % and 19 to 50% with respect to the total weight of the coating layer.

Additionally, the coating layer may have an average thickness of 50 μm to 500 μm.

In addition, the coating layer may have a pattern structure with an area ratio of 50 to 90% with respect to the total surface area of the case.

Moreover, the internal gas may include one or more selected from oxygen(O₂), hydrogen(H₂), ethylene(C₂H₄), acetylene(C₂H₂), propylene(C₃H₆), carbon monoxide(CO), carbon dioxide(CO₂), methane(CH₄), ethane(CH₃CH₃), propane(CH₃CH₂CH₃), nitrogen monoxide(NO) or nitrogen dioxide(NO₂).

In addition, the secondary battery may also include a means of gas emission venting under pressure.

Furthermore, in one embodiment, the present invention provides a secondary battery module that includes the secondary battery according to the present invention described above.

### Advantageous Effects

The secondary battery according to the present invention absorbs gas in a normal operating temperature on the basis of a critical temperature, and by having a gas absorbing material that desorbs internal gas absorbed in a high temperature coated on the inner side of the case, it is possible to reach an internal pressure critical point in a short time when exposed to an abnormally high temperature, thus it can better improve the safety for heat transfer and fire in the battery because it can hasten the internal gas emission point.

In addition, the secondary battery inhibits deformation of the battery case by absorbing gas generated in a normal operating temperature range and lowering the pressure inside the battery case, and it has an excellent effect in not degrading the battery performance.

### BRIEF DESCRIPTION OF THE DRAWINGS

FIG. 1 is a cross-sectional view illustrating the structure of a pouch-type secondary battery according to an exemplary embodiment of the present invention.

FIG. 2 is a cross-sectional view illustrating the structure of a pouch-type secondary battery according to another exemplary embodiment of the present invention.

FIG. 3 is a graph(a) representing CO₂ absorption isotherm of a general CO₂ absorbent, and a graph(b) representing a CO₂ absorption isotherm of an absorbent of mmen-M2(dobpdc).

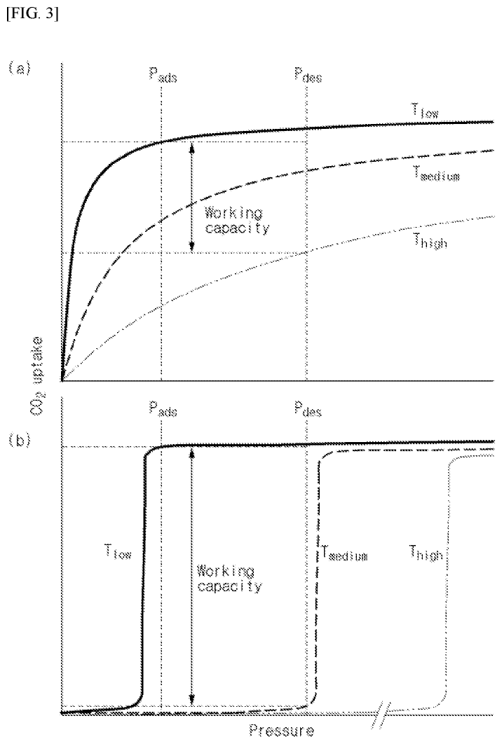

### BEST MODE FOR CARRYING OUT THE INVENTION

Hereinafter, while it will be described by referring to the drawings according to the embodiments of the present invention, they are only for facilitating the understanding of the present invention, and the category of the present invention is not limited to specific embodiments.

### Secondary Battery

The present invention, in one embodiment, provides a secondary battery that includes
an electrode assembly; and
a case where the electrode assembly gets inserted,
wherein the case has a coating layer on the inner side that contains a gas absorbing material that absorbs or desorbs internal gas depending on the temperature inside the case.

The secondary battery according to the present invention includes an electrode assembly, and the electrode assembly has a shape inserted into a case. Here, while the case can be widely applied depending on the shape, structure, and manufacturing method of the secondary battery, it can specifically be applied to a cylindrical, prismatic, pouch-type, etc. In one example, the case mentioned above may be a pouch-type case.

In addition, the case may have a coating layer on its inner side containing a gas absorbing material that absorbs or desorbs internal gas generated during charge/discharge of the secondary battery. Specifically, the case may include a coating layer in a mixed form of a gas absorbing material and a binder that fixes it on the inner surface where an electrode assembly is being placed.

Here, the gas absorbing material contained in the coating layer has a critical temperature of 70 to 150° C., and it may absorb internal gas below the critical temperature and may desorb internal gas at or above the critical temperature. That is, the gas absorbing material lowers the pressure inside the case by absorbing internal gas generated due to charge/discharge of the battery in a normal operating temperature which is at or below the critical temperature, and when heat gets generated above the critical temperature due to abnormal operation of the battery, it can quickly vent open the internal gas before thermal runaway by desorbing the absorbed gas and increasing the gas pressure inside the case in a short time or in an instant.

For this purpose, the gas absorbing material may have a critical temperature of 70 to 150° C., specifically between 70˜130° C.; 70˜110° C.; 70˜90° C.; 90˜120° C.; 100˜110° C.; 110˜125° C.; or 120˜140° C. The present invention absorbs internal gas in a normal operation temperature and effectively desorbs gas in an abnormal operation temperature, for example, in heating condition, to increase internal pressure in a short time or in an instant, by controlling the critical temperature of gas absorbing material to the above range.

While such gas absorbing material may be applied without being limited if it is absorbing or desorbing gas on the basis of a critical temperature between 70 and 150° C., it may specifically comprise a diamine compound including one or more metals selected from the group consisting of magnesium, manganese, iron, zinc, and cobalt. Besides the diamine compounds, materials that collect gas by having a porous structure such as carbon fiber, activated carbon, zeolite, alumina, silica, bauxite, and molecular sieves, etc. can be used alone or in combination.

In one example, the gas absorbing material may include the diamine compound with a critical temperature between 70 and 90° C. including one or more selected from the group consisting of mmen-Mg₂(dobpdc), mmen-Mn₂(dobpdc), mmen-Fe₂(dobpdc), mmen-Zn₂(dobpdc), and mmen-Co₂(dobpdc). Here, “mmen” means N,N-diethylethylenediamine, and “Dobpdc” means 4,4′-dioxidobiphenyl-3,3′-dicarboxylate.

The diamine compound is an uncoordinated amine compound of mmen molecule, eliminating acidic protons from the metal binding amine of neighboring mmen molecule, and phase transition occurs during gas (CO₂, for example) absorption where carbamate that has opposite cation to that of ammonium is formed. If an appropriate temperature and pressure are applied, rearrangement of carbamate becomes possible, where M-N bond breaks and M-O bond is formed. The ion-pairing interaction elongates the mmen molecule and makes M-N bond unstable, stimulating gas (CO₂, for example) insertion into the next metallic part. Such synergistic effect is extended until a complete one-dimensional ammonium-carbamate chain is formed, and large amount of gas (CO₂, for example) is absorbed due to the synergistic effect, causing the absorption isotherm to appear in a steep vertical form.

In contrast, if the gas (CO₂, for example) applies a higher temperature and pressure to the absorbed mmen-M₂(dobpdc), the gas absorption mechanism from the above happens the other way around, where M-O bond breaks and M-N bond gets formed, making the gas (CO₂, for example) to be desorbed and destabilizing surrounding M-O bonds, and the synergistic effect that stimulates separation of the gas (CO₂, for example) in the next metallic part occurs. This causes large amount of gas (CO₂, for example) to be rapidly desorbed.

Meanwhile, in mmen-M₂(dobpdc), the metal-amine bonding strength varies depending on the type of divalent metal M, causing the location of the absorption stage and the desorption stage to be different, and the location of the absorption stage and the desorption stage given the same temperature changes in the order of Mg<Mn<Fe<Zn<Co. That is, internal gas is absorbed when the mmen-M₂(dobpdc) is lower than the critical temperature and internal gas is emitted when the mmen-M₂(dobpdc) is higher than the critical temperature, and the critical temperature where the absorption and desorption of internal gas is switched can be controlled by selecting an appropriate M.

The present invention uses the gas (CO₂, for example) absorption and desorption properties of mmen-M₂(dobpdc), and the internal gas such as CO₂ that is generated during the normal charge-discharge process of the secondary battery increases the absorption rate using a gas absorbing material of the mmen-M₂(dobpdc). And when an abnormal reaction such as temperature rise due to a short circuit in the secondary battery occurs, it sharply raises the internal pressure of the secondary battery case by rapidly desorbing internal gas that has been absorbed into the gas absorbing material at temperature at or above the critical temperature, causing the gas to be emitted by rupturing the rupture element of the means of gas emission. Accordingly, this can prevent a series of heat transfer to adjacent secondary batteries by quickly disabling the secondary battery that has shown an abnormal reaction within the secondary battery module.

In another example, the gas absorbing material may be a zeolite, activated alumina, and/or silica gel that has a critical temperature between 110 and 140° C. While zeolite, activated alumina, and/or silica gel contain the same chemical components, their critical temperature may vary due to a post-treatment process such as a heat treatment, a surface treatment, and a surface coating, as well as due to processing condition in manufacturing or doping within the material. And the critical temperature may be appropriately controlled in accordance with the internal temperature range predicted based on the operating condition of the secondary battery.

In addition, while the coating layer contains a gas absorbing material, it may contain two or more gas absorbing materials with different critical temperature. When the coating layer contains two or more gas absorbing materials with different critical temperature, internal gas can be easily controlled to a predetermined temperature range for it to be emitted.

Specifically, the coating layer may include a first gas absorbing material that has a critical temperature between 70 and 110° C.; a second gas absorbing material that has a critical temperature between 110 and 140° C.; and a binder.

In one example, the coating layer may include a first gas absorbing material that has a critical temperature between 80 and 95° C.; a second gas absorbing material that has a critical temperature between 115 and 130° C.; and a binder.

In another example, the coating layer may include a first gas absorbing material that has a critical temperature between 100 and 110° C.; a second gas absorbing material that has a critical temperature between 110 and 120° C.; and a binder.

Here, while the first gas absorbing material absorbs the gas generated during normal operation of the secondary battery and/or from internal temperature condition below the critical temperature and reduces the internal pressure, if the internal temperature exceeds the critical temperature, 70110° C. in specific, due to an abnormal operation of the secondary battery, it may substantially increase the internal pressure by desorbing the absorbed gas.

In addition, because the second gas absorbing material has a higher critical temperature compared to that of the first gas absorbing material, it can prevent the damage in an electrode assembly inserted into the secondary battery by partially absorbing gas desorbed from the first gas absorbing material when the internal temperature exceeds the critical temperature of the first gas absorbing material due to an abnormal operation of the secondary battery. It may also increase the internal pressure of the secondary battery in a short time or in an instant by desorbing the absorbed gas before heat transfer occurs to the secondary battery adjacent to the relevant secondary battery inside the secondary battery. For this purpose, the first gas absorbing material may have a critical temperature that is lower than the temperature where heat transfer of the secondary battery occurs.

Moreover, the first and the second absorbing material may be included into the coating layer with a certain weight ratio. Specifically, the first gas absorbing material and the second gas absorbing material may each be comprised at 60 to 80 wt % and 19 to 50% with respect to the total weight of the coating layer, and more specifically they may each be comprised at 65 to 75 wt % and 24 to 40 wt %; or 62 to 70 wt % and 29 to 35 wt % with respect to the total weight.

The present invention, by controlling the content of the first and the second gas absorbing material contained in the coating layer to the above range, can keep the internal pressure of the battery low in a normal operating temperature of the battery. When the internal temperature exceeds 120° C. due to an abnormal operation of the battery, more specifically under temperature condition at or above 140° C., it can desorb internal gas and momentarily increase the internal pressure before thermal runaway of the battery occurs. This allows internal gas to be emitted outside the case in a lower temperature condition, better improving the safety of the battery.

In addition, although the coating layer is formed on the inner side of the case, it may be formed on all sides of the inner part of the case to surround the electrode assembly inserted into the case, and in some cases, a pattern structure can be formed in order to increase the surface area. The coating layer may be formed on all sides of the inner part of the case in a form surrounding the electrode assembly in order to absorb gas generated from a side reaction between the active materials of the electrode assembly and/or between the active material and electrolyte during charge-discharge of the battery; and while it may be formed on all sides of the inner part of the case, it is formed with a pattern structure so that it can more effectively absorb internal gas of the battery by increasing the surface area.

Here, if the coating layer has a pattern structure, the coating layer may be formed with an area ratio between 50 and 90% with respect to the total surface area of the case, specifically formed with an area ratio between 60 and 90%; 70 and 90%; 75 and 90%; or 70 and 85% with respect to the total surface area of the case.

In addition, the coating layer may have an average thickness between 50 μm and 500 μm, specifically between 50 μm and 400 μm; 50 μm and 300 μm; 50 μm and 200 μm; 100 μm and 300 μm; 150 μm and 300 μm; or 80 μm and 150 μm.

The present invention may prevent the energy density from decreasing, and maximize the gas absorption rate by controlling the area ratio and average thickness of the coating layer to the above range.

Meanwhile, the internal gas being generated from the inside of the battery during the charge-discharge of the secondary battery is originated from either the decomposition of a positive electrode, an negative electrode, and/or a separation membrane that forms the electrode assembly or the decomposition of an electrolyte, and its type may not be particularly limited.

Specifically, the internal gas may comprise one or more selected from oxygen(O₂), hydrogen(H₂), ethylene(C₂H₄), acetylene(C₂H₂), propylene(C₃H₆), carbon monoxide(CO), carbon dioxide(CO₂), methane(CH₄), ethane(CH₃CH₃), propane(CH₃CH₂CH₃), nitrogen monoxide(NO) or nitrogen dioxide(NO₂).

In one example, the internal gas may be a carbon monoxide(CO) and/or carbon dioxide(CO₂). If heat gets generated due to an abnormal operation during the charge-discharge of the battery, a considerable amount of carbon monoxide(CO) and/or carbon dioxide(CO₂) gets formed by the electrolyte decomposition. The present invention may effectively control internal pressure due to gas by absorbing/desorbing carbon monoxide(CO) and/or carbon dioxide(CO₂) at a high rate.

In addition, the secondary battery according to the present invention may also include a means of gas emission in order to emit gas to the case where the electrode assembly is inserted.

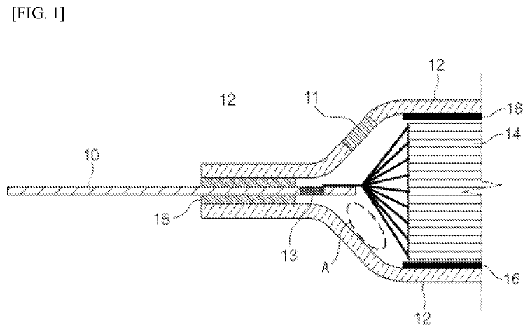

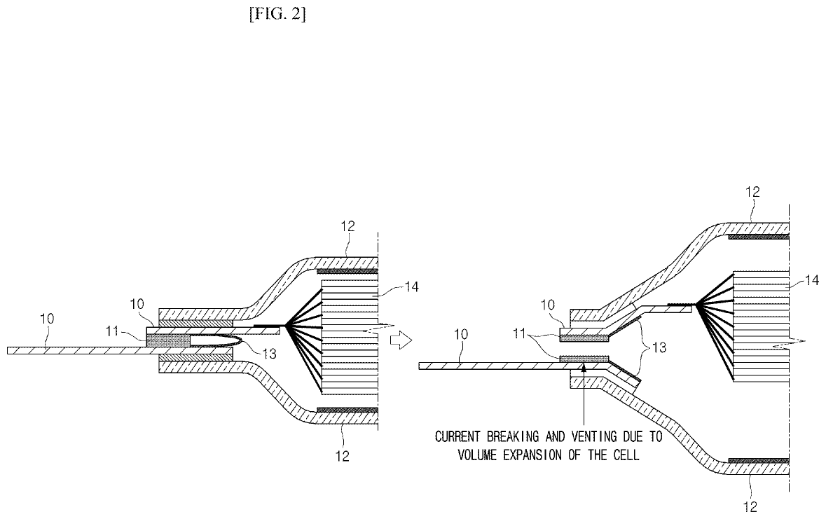

FIG. 1 and FIG. 2 are cross-sectional views illustrating the structure of the secondary battery according to present invention, and the structure of the secondary battery of the present invention is composed of an electrode lead 10 and a case 12 accommodating an electrode assembly 14. The electrode lead 10 is connected to a case 12 via a sealing part 15, and it is partially exposed to the outside of the case 12.

Here, the case 12 may additionally include a means of gas emission 11 that vents internal gas when the internal pressure steeply increases by internal gas being desorbed from the coating layer 16 due to an abnormal operation of the battery.

Specifically, as illustrated in FIG. 1, the means of gas emission can be formed on one side of the case 12, or, as illustrated in FIG. 2, can be formed between the electrode lead 10 and an electrode tab 10′. Internal gas such as CO, CO₂, etc. can be formed due to temperature rise when an abnormal reaction occurs during the charge-discharge process of the secondary battery. As a result, the internal pressure of the secondary battery case 12 rises, causing the case deformation and safety related issues such as fire may occur. The means of gas emission 11 is directed to solve the above-mentioned issues, and while it is not limited to a specific form, the means of gas emission 11 may include: an opening part (not illustrated) that connects the inside and outside of the secondary battery case and a rupturing part (not illustrated) that seals the inside of the secondary battery case and gets ruptured when the internal pressure of the secondary battery case increases.

Additionally, the secondary battery according to one embodiment of the present invention may contain a current blocking part. The current blocking part may be a fuse that is short-circuited when temperature rises, and may be formed in a structure that is separated by an increased pressure due to internal gas generation. The present invention uses the sudden desorption of the internal gas by a gas absorbing material, and it is desirable for the current blocking part to have a structure that blocks the current by being separated due to pressure.

In other words, the secondary battery according to the present invention desorbs gas that has been absorbed to the gas absorbing material when temperature rises due to an abnormal reaction inside the battery; when the pressure inside the secondary battery case 12 exceeds above a certain level, the means of gas emission 11 gets vented, emitting activated gas, gas generated by the charge-discharge of the battery, and/or gas generated by the battery being exposed to a high temperature; and the secondary battery stops working due to a current blocking element 13.

### Secondary Battery Module

Furthermore, the present invention provides a secondary battery module that includes the secondary battery according to the present invention stated above.

The secondary battery module according to the present invention includes the secondary battery according to the present invention that has a coating layer containing a gas absorbing material that absorbs or desorbs gas based on the critical temperature on the inner side of the case.

Accordingly, the secondary battery module absorbs internal gas at a normal operating temperature of the battery, and desorbs the absorbed internal gas when heat gets generated due to an abnormal operation of the battery, allowing it to reach the internal pressure critical point of the battery in a short time and easily control the internal gas emission time point, which is an excellent advantage in terms of safety.

Because the secondary battery module according to the present invention has excellent safety when exposed to high temperature by having a composition that has the secondary battery of the present invention, it can be used as a power source for medium and large size devices which require high-temperature safety, long cycle properties, high-rate properties, etc. Specific examples of medium and large size devices may include a power tool that moves by being powered by an electrical motor; electric cars including Electric Vehicle (EV), Hybrid Electric Vehicle (HEV), Plug-in Hybrid Electric Vehicle(PHEV), etc.; electric two-wheel vehicles including an E-bike and an Escooter; an electric golf cart; and a power storage system. More specifically, it can include Hybrid Electric Vehicle (HEV), but it is not limited thereto.

### MODE FOR CARRYING OUT THE INVENTION

Hereinafter, the present invention will be described in further detail with reference to examples and an experimental example.

However, the following examples and an experimental example merely illustrate the present invention, and the content of the present invention is not limited to the following examples and an experimental example.

### Examples 1-4. Manufacture of Secondary Battery

A Secondary battery was manufactured by preparing an electrode assembly that has a positive electrode, a negative electrode, and a separation membrane interposed between the positive electrode and the negative electrode, inserting the prepared assembly into a pouch-type case, injecting an electrolyte, and sealing the case.

Here, the case with a means of gas emission on one side as illustrated in FIG. 1 and a coating layer (an average thickness: approx. 50μm) on the inner side was used. While the coating layer contained 97 wt % of a gas absorbing material and 3 wt % of a binder, a first gas absorbing material (a critical temperature: approx. 75˜80° C.), a second gas absorbing material (a critical temperature: approx. 125˜130° C.), and the area ratio were controlled as illustrated in Table 1 below.

TABLE 1

| | First Gas absorbing | | Second Gas Absorbing | | |
|---|---|---|---|---|---|
| | Material | | Material | | |
| | Component | Content | Component | Content | Area Ratio |
| Example 1 | mmen- | 97 wt % | — | — | 100% |
| | M₂(dobpdc) | | | | |
| Example 2 | mmen- | 97 wt % | — | — | 80% |
| | M₂(dobpdc) | | | | (striped |
| | | | | | structure) |
| Example 3 | — | — | Activated | 97 wt % | 80% |
| | | | Alumina | | (striped |
| | | | | | structure) |
| Example 4 | mmen- | 65 wt % | Activated | 32 wt % | 80% |
| | M₂(dobpdc) | | Alumina | | (striped |
| | | | | | structure) |

### Comparative Example 1. Manufacture of Secondary Battery

Besides using a case that does not have a coating layer formed on the inner side, the same method as in Example 1 was performed to manufacture a secondary battery.

### Experimental Example

The time that takes for internal gas to be emitted (that is, vented) from the means of gas emission of each secondary battery and the internal temperature of the secondary battery when internal gas is being emitted were measured by performing overcharging of secondary batteries manufactured in the Examples and Comparative Example.

Specifically, a temperature sensor was introduced to the inside of the secondary batteries manufactured in the Examples and Comparative Example, and after charging the battery to 4.2V, it was overcharged with a constant current of 0.05 C until it reached 10V. In the overcharging process, the internal temperature of the battery was measured when the means of gas emission emitted the internal gas. The result is shown in Table 2 below.

TABLE 2

| | Internal Temperature During Venting | |
|---|---|---|
| Example 1 | 95° | C. |
| Example 2 | 93° | C. |
| Example 3 | 140° | C. |
| Example 4 | 115° | C. |

| | |
|---|---|
| Comparative Example 1 | Ignition occurred before venting |

As shown in Table. 2 above, the secondary battery according to the present invention can have its safety improved by having a coating layer containing a gas absorbing material that absorbs and desorbs internal gas depending on the critical temperature on the inner side of the case.

Specifically, the secondary battery of the examples can easily control the internal pressure of the battery when exposed to a high temperature due to an abnormal operation of the battery by having a coating layer containing a gas absorbing material formed on the inner side of the case, and it can perform the internal gas emission before the thermal runaway of the battery gets induced.

On the other hand, in the secondary battery of comparative example that does not have a coating layer formed, it has been confirmed that venting is proceeded after the thermal runaway of the battery.

From these results, it can be known that the secondary battery according to the present invention may further enhance the safety in terms of battery heat transfer and fire by having a gas adsorbing material that absorbing internal gas in a normal operating temperature based on a critical temperature and desorbs the absorbed internal gas in a high temperature coated on the inner side of the case.

As above, the present invention has been described with reference to exemplary embodiments, but it should be understood by those skilled in the art or those of ordinary skill in the art that the present invention can be variously modified and changed without departing from the spirit and technical scope of the present invention described in the accompanying claims.

Accordingly, the technical scope of the present invention is not limited to the content described in the detailed description of the specification, but should be defined by the claims.

1. A secondary battery, comprising:
an electrode assembly; and
a case where the electrode assembly is inserted, wherein the case has an inner side, and
wherein the case has a coating layer on the inner side containing a gas absorbing material that absorbs or desorbs internal gas depending on a temperature inside the case.

2. The secondary battery of claim 1, wherein the gas absorbing material has a critical temperature between 70° C. and 150° C. wherein the gas absorbing material absorbs internal gas below the critical temperature and wherein the gas absorbing material desorbs internal gas at or above the critical temperature.

3. The secondary battery of claim 1, wherein the gas absorbing material comprises a diamine compound containing one or more metals selected from the group consisting of magnesium, manganese, iron, zinc, and cobalt.

4. The secondary battery of claim 3, wherein the diamine compound comprises one or more selected from the group consisting of mmen-Mg₂(dobpdc), mmen-Mn₂(dobpdc), mmen-Fe₂(dobpdc), mmen-Zn₂(dobpdc), and mmen-Co₂(dobpdc).

5. The secondary battery of claim 1, wherein
the gas absorbing material comprises one or more selected from the group consisting of carbon fiber, activated carbon, zeolite, alumina, silica, bauxite, and molecular sieves.

6. The secondary battery of claim 1, wherein the coating layer comprises:
a first gas absorbing material that has a critical temperature between 70 and 110° C.;
a second gas absorbing material that has a critical temperature between 110 and 140° C.; and
a binder.

7. The secondary battery of claim 6, wherein the coating layer comprises 60 wt % to 80 wt % of the first gas absorbing material and 19 wt % to 50 wt % of the second gas absorbing material with respect to a total weight of the coating layer.

8. The secondary battery of claim 1, wherein the coating layer has an average thickness of 50 μm to 500 μm.

9. The secondary battery of claim 1, wherein the coating layer has a pattern structure with an area ratio of 50 to 90% with respect to a total surface area of the case.

10. The secondary battery of claim 1, wherein the internal gas comprises one or more selected from oxygen (O₂), hydrogen (H₂), ethylene (C₂H₄), acetylene (C₂H₂), propylene (C₃H₆), carbon monoxide (CO), carbon dioxide (CO₂), methane (CH₄), ethane (CH₃CH₃), propane (CH₃CH₂CH₃), nitrogen monoxide (NO) or nitrogen dioxide (NO₂).

11. The secondary battery of claim 1, wherein the secondary battery further comprises a gas emission vent under pressure.

12. A secondary battery module that comprises the secondary battery of claim 1.
